(19) United States
(12) Patent Application Publication
(10) Pub. No.: US 2015/0016698 A1
(43) Pub. Date: Jan. 15, 2015

(54) ELECTRONIC DEVICE PROVIDING BIOMETRIC AUTHENTICATION BASED UPON MULTIPLE BIOMETRIC TEMPLATE TYPES AND RELATED METHODS

(71) Applicant: APPLE INC., Cupertino, CA (US)

(72) Inventor: GREGORY L. KERR, Indialantic, FL (US)

(21) Appl. No.: 13/938,400

(22) Filed: Jul. 10, 2013

(51) Int. Cl. G06K 9/00

(52) U.S. Cl. CPC G06K 9/00013; G06K 9/00073; G06K 9/0008
USPC 382/125

(57) ABSTRACT

An electronic system may include an authentication device capable of performing authentication based upon a first type of finger biometric template, and an electronic device. The electronic device may include a wireless transceiver, a finger biometric sensor, and a processor cooperating with the finger biometric sensor and capable of performing authentication based upon a second type of finger biometric template different from the first type of finger biometric template, and generating finger biometric data according to the first type of finger biometric template. The processor may also be capable of cooperating with the authentication device to authenticate the finger biometric data according to the first type of finger biometric template.

### BACKGROUND

Fingerprint sensing and matching is a reliable and widely used technique for personal identification or verification. In particular, a common approach to fingerprint identification involves scanning a sample fingerprint or an image thereof and storing the image and/or unique characteristics of the fingerprint image. The characteristics of a sample fingerprint may be compared to information for reference or enrolled fingerprints already in a database to determine proper identification of a person, such as for verification purposes.

Traditional approaches for fingerprint matching sometimes rely on templates of minutia, which are point features corresponding to ridge ends and bifurcations. Other approaches use fingerprint pattern features for template matching. Examples of fingerprint pattern features include image pixel values, ridge flow, and ridge frequency.

With the existence of these various fingerprint matching techniques, enrollment and matching across different platforms may be problematic. That is, different devices and systems may use different authentication approaches, which may prevent desired interoperability in some circumstances.

### SUMMARY

An electronic system may include an authentication device capable of performing authentication based upon a first type of finger biometric template. The system may also include an electronic device including a wireless transceiver, a finger biometric sensor, and a processor cooperating with the finger biometric sensor and capable of performing authentication based upon a second type of finger biometric template different from the first type of finger biometric template, and generating finger biometric data according to the first type of finger biometric template. The processor may also be capable of cooperating with the authentication device to authenticate the finger biometric data according to the first type of finger biometric template.

More particularly, the electronic device may further include a wireless transceiver, and the processor may be capable of sending finger biometric data according to the first type of template to the authentication device via the wireless transceiver based upon an authentication of corresponding finger biometric data of the second type of finger biometric template. By way of example, the first type of biometric template may comprise a fingerprint minutiae template, and the second type of biometric template may comprise a fingerprint ridge flow template.

The processor may be capable of encrypting the finger biometric data according to the first type of finger biometric template. In addition, the processor may be capable of cooperating with the finger biometric sensor to simultaneously collect biometric data for both the first type of finger biometric template and the second type of finger biometric template. The processor may also be capable of cooperating with the finger biometric sensor to collect finger biometric data for the second type of finger biometric template and extract therefrom biometric data for the first type of finger biometric template.

Furthermore, the processor may be further capable of cooperating with the authentication device to perform a transaction. By way of example, the transaction may comprise at least one of a financial transaction and a physical access transaction.

A related electronic device, such as the one described briefly above, and an authentication method are also provided. The authentication method may be for use with an authentication device to perform authentication based upon a first type of finger biometric template. The method may include operating a processor to cooperate with a finger biometric sensor to perform authentication based upon a second type of finger biometric template different from the first type of finger biometric template, generate finger biometric data according to the first type of finger biometric template, and cooperate with the authentication device to authenticate the finger biometric data according to the first type of finger biometric template.

A related non-transitory computer-readable medium is for an electronic device, such as the one described briefly above, to cooperate with an authentication device to perform authentication based upon a first type of finger biometric template. The computer-readable medium may have computer executable instructions for causing the electronic device to perform authentication based upon a second type of finger biometric template different from the first type of finger biometric template based upon the finger biometric sensor, generate finger biometric data according to the first type of finger biometric template, and cooperate with the authentication device to authenticate the finger biometric data according to the first type of finger biometric template.

### BRIEF DESCRIPTION OF THE DRAWINGS

FIG. 1 is schematic block diagram of an electronic system in accordance with an example embodiment.

FIGS. 2 and 3 are flow diagrams illustrating method aspects associated with the system of FIG. 1.

FIGS. 4 and 5 are front views of an example embodiment of the electronic device of the system of FIG. 1 illustrating finger biometric data collection and communication aspects.

### DETAILED DESCRIPTION

The present disclosure is provided with reference to the accompanying drawings, in which example embodiments are shown. However, other embodiments may be used in different applications, and this disclosure should accordingly not be construed as limited to the particular embodiments set forth herein. Rather, these embodiments are provided by way of example so that this disclosure will be thorough and complete. Like numbers refer to like elements throughout.

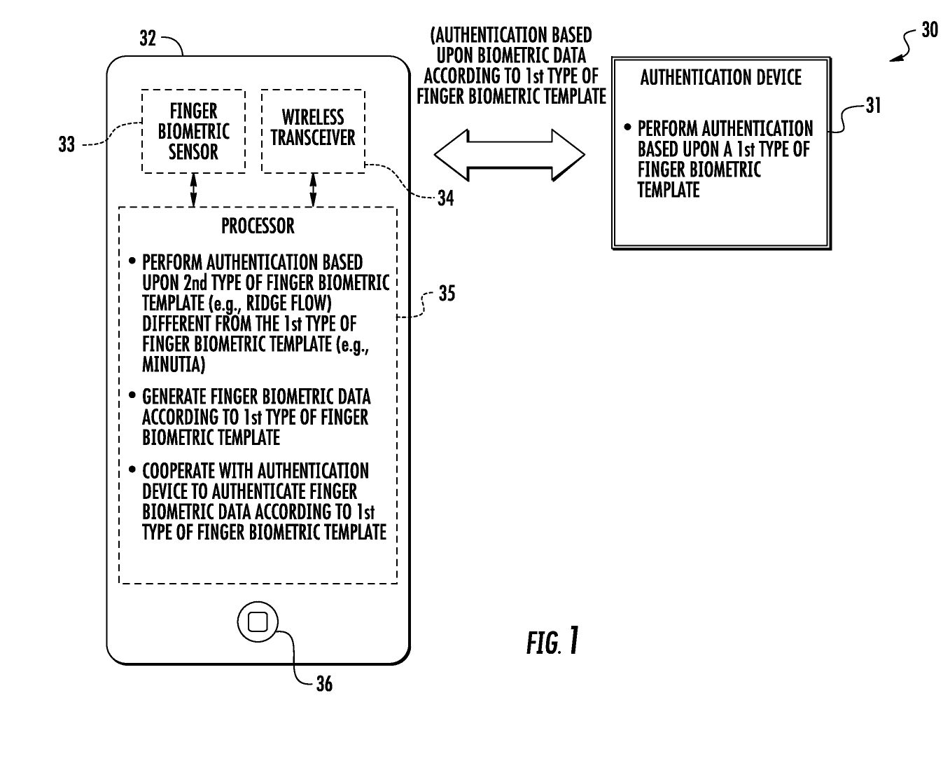

Referring initially to FIG. 1, an electronic system 30 illustratively includes an authentication device 31 and an electronic device 32. By way of example, the authentication device 31 may be a server or terminal that is used to authenticate the electronic device 32 (or its associated user) to perform transactions such as financial transactions (e.g., banking transactions, purchases, etc.) or physical access transactions (e.g., access at a security gate, a locked room, vault, safe deposit box, locker, etc.).

In the illustrated example, the electronic device 32 is a smartphone. Other example electronic devices may include telephones, laptop computers, tablet computers, personal digital assistants (PDAs), digital cameras, gaming devices, digital display devices, desktop computers, etc. The electronic device 32 illustratively includes a finger biometric sensor 33, a wireless transceiver 34, and a processor 35 cooperating with the finger biometric sensor and the wireless transceiver. In the illustrated example, the electronic device 32 further illustratively includes a button 36 as an input device, which may be used as a “Home” or menu button in some implementations. Other example input devices which may be used include a touch screen display, buttons, a physical keypad, holographic keypad, etc., and different input device configurations may be used in different embodiments.

By way of example, the processor 35 may be implemented using a combination of hardware (e.g., microprocessor, etc.) and a non-transitory computer-readable medium having computer-executable instructions for performing the various operations described herein. The finger biometric sensor 33 may be implemented as a stand-alone electronic device (e.g., a finger biometric chip or chipset), or some of the operations may be performed by shared resources of the electronic device 32 (e.g., a device microprocessor, etc.). By way of example, the finger biometric sensor 33 is illustratively a static fingerprint sensor, but it may be a swipe sensor in other embodiments. The finger sensing array may be located at different positions on the electronic device 32, such as on a housing of the electronic device, integrated with the button 36 as shown, or as part of a touch screen sensor array, for example.

Also by way of example, the first wireless transceiver 34 may be a cellular transceiver, wireless local area network (WLAN) transceiver, etc. Other types of wireless transceivers 34 may include short-range communications transceivers such as Bluetooth or near-field communication (NFC) transceivers, for example. The wireless transceiver 34 may be used to communicate with the authentication device directly via WLAN, Bluetooth, NFC, etc., or via the Internet via WLAN or cellular communication, for example, depending upon the given implementation. That is, the authentication device 31 and the electronic device 32 may be co-located or geographically spaced apart, depending upon the given implementation. The authentication device 31 may be capable of or configured to perform authentication for various operations, such as those noted above, based upon a first type of finger biometric template, as will be discussed further below.

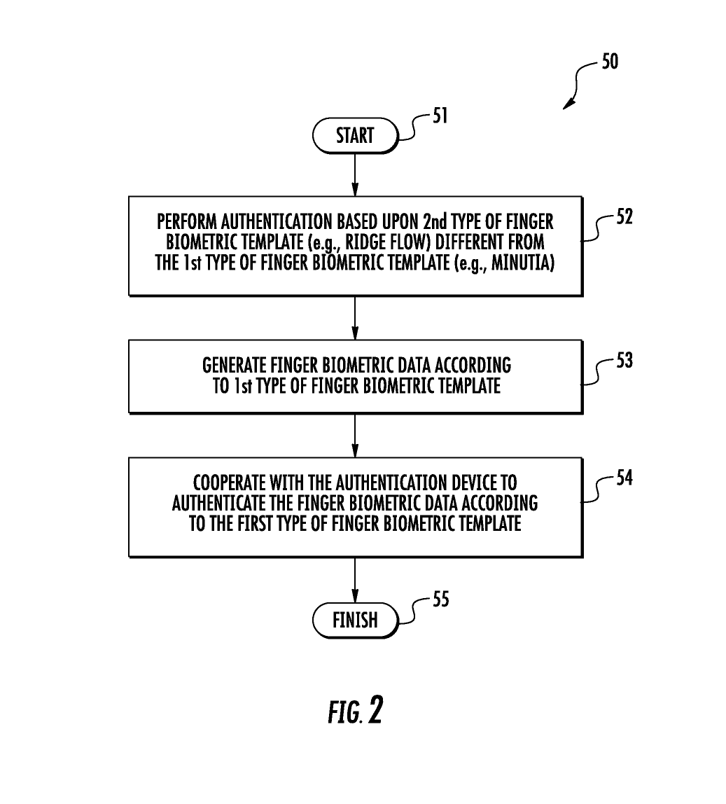

Referring additionally to the flowchart 50 of FIG. 2, beginning at Block 51, the processor 35 may be capable of or configured to perform authentication based upon a second type of finger biometric template different from the first type of finger biometric template, at Block 52, and generate finger biometric data according to the first type of finger biometric template, at Block 53. The processor 35 may also be capable of cooperating with the authentication device 31 to authenticate the finger biometric data according to the first type of finger biometric template, at Block 54. The method illustratively concludes at Block 55.

By way of background, international fingerprint systems typically utilize minutiae templates for authentication. Examples of such systems include India's universal ID (UID) program; the Minutiae Interoperability Exchange Test (MINEX); Fingerprints, Identifications and Pardons Services (FIPS); U.S. Immigration, etc. Such systems may be referred to a “one-to-many” comparison systems, as they attempt to match a given set of minutiae data against many different sets of enrolled minutiae data to determine a match. Yet, it may be desirable to use other types of finger biometric templates, such as ridge flow data, for example, for authentication on electronic devices which are less time or processing intensive. However, to interoperate with minutiae-based systems, the electronic device 32 may also need to be able to store, process, and/or communicate such data.

In the example embodiments described herein, the first type of finger biometric template will accordingly be a minutiae template, while the second type of finger biometric template will be a ridge flow template. However, it should be noted that the first or second type of finger biometric template could include other types of finger biometric data, such as image pixel values, ridge frequency, vein matching, etc.

In the above-noted example where the finger sensor array is co-located with the button 36, the sensing area will be relatively small, that is, it may be less than the total sensable area of a user's finger. However, this sensor array may be used to collect or generate a minutiae template or map over time, as well as a minutiae template that is compatible with systems using the above-noted minutiae-based standards, for example.

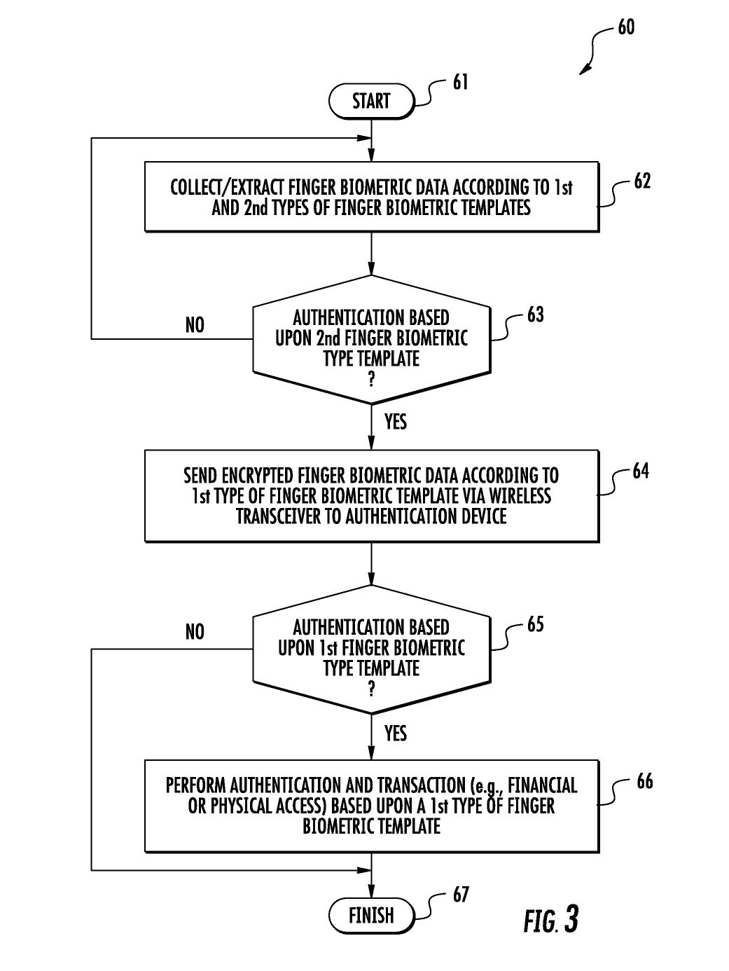

Referring more particularly to the flow diagram 60 of FIG. 3, beginning at Block 61, a buildup of minutiae data may be performed in parallel to ridge flow data collection. Depending upon the given finger biometric sensor arrangement used, the sensor array may simultaneously collect ridge flow and minutiae data when a scan of a user's finger is performed, or collect one type of data may be collected and the other type of data may be extracted from the collected type (Block 62). Over time the collected/extracted data may be compiled or assimilated into respective ridge flow and minutiae templates or maps corresponding to the overall sensable area of the user's finger(s). Moreover, both minutiae and ridge flow data may be generated from raw or processed image data, as will be appreciated by those skilled in the art.

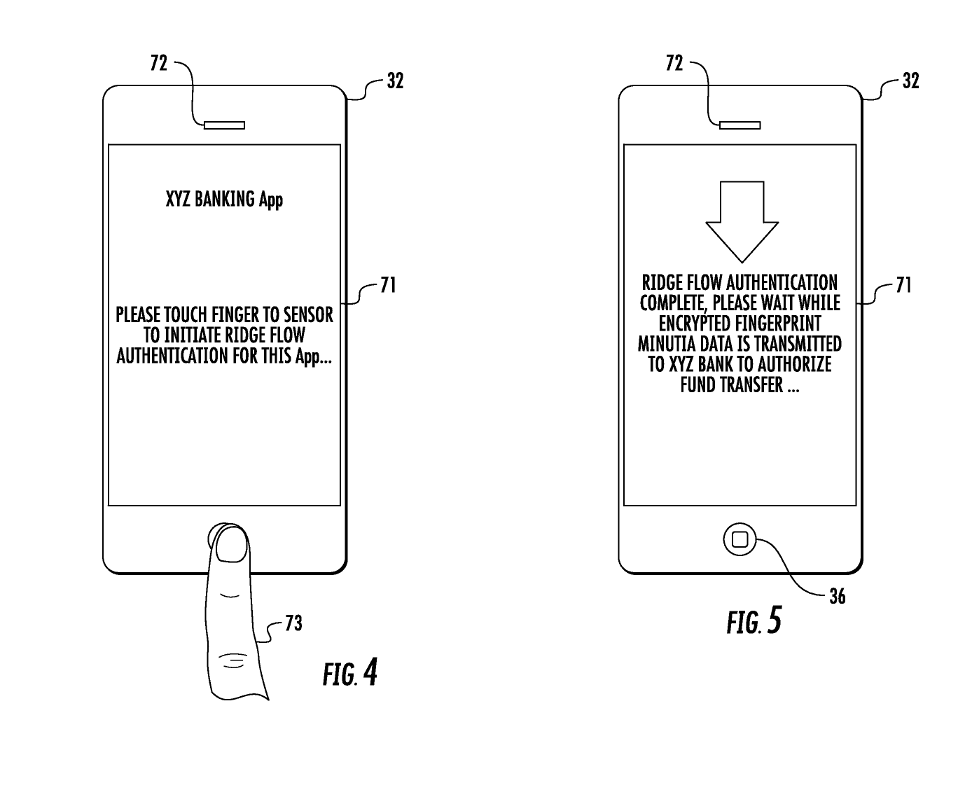

Accordingly, the ridge flow template biometric and/or extraction/conversion from ridge-flow to minutiae may enable the use of one-to-many systems, both by a carrier network or mobile device manufacturer, as well as externally to enable integration with third party identification or authentication systems. Referring additionally to the example illustrated in FIGS. 4 and 5, the electronic device 32 further includes a display 71 (e.g., a touch screen display) and a speaker 72. The processor 35 (not shown in FIGS. 4 and 5) provides a prompt on the display 71 for the user to place the user's enrolled finger 73 on the sensor area to collect ridge flow data. The collected ridge flow data is then compared to an enrolled ridge flow template for the user at the electronic device, at Block 63. The ridge flow authentication may be used to wake the electronic device 32 from a sleep or locked mode, or to specifically enable a given financial or security app, for example. In the illustrated example, the collected ridge flow data is used to authenticate the user for using a banking app for XYZ Bank, and a message is provided on the display 71 instructing the user to touch the finger 73 to the finger sensor area to perform the ridge flow authentication operation (FIG. 4).

Upon verification of the ridge flow data, the banking app may then be enabled to send finger biometric data according to the first type of finger biometric template (i.e., a minutiae template in the present example) to the authentication device 31, at Block 64, which in this example would be a banking server for XYZ Bank (see FIG. 5). In some embodiments, this data may be encrypted prior to sending to the authentication device 31 to provide enhanced security, as well as compliance with applicable laws regarding the transmission of biometric data, as appropriate. More particularly, shared secret encryption may be used to help ensure any biometric data that is transmitted across a public network is in an encrypted standards-compliant template, if desired. For example, certain jurisdictions may have different regulations with respect to different types of biometric data, such that it may be desirable to transmit one type of data over a communications network (e.g., minutiae data) but not another (e.g., ridge flow data).

It should also be noted that, at an initial instance, the finger biometric data according to the first type of finger biometric template sent to the authentication device 31 may be used as enrollment data. That is, the finger biometric data provided by the electronic device 32 to the authentication device 31 may be used for both enrollment and matching purposes. The approach set forth herein may accordingly be used to “instantly enroll” a user with systems that are built around minutiae standards, for example, thereby allowing later verification with various public terminals, etc., as will be appreciated by those skilled in the art.

Once the minutiae data is decrypted and authenticated by the authentication device 31, the authentication device may perform the appropriate transaction or operation, at Block 66, which illustratively concludes the method of FIG. 3 (Block 67). In the present example, the transaction is a transfer of funds by the XYZ server, although it will be appreciated that numerous other financial transaction (e.g., purchases, bill payment, etc.), security transactions, etc., may also be performed in different embodiments.

In the above-described example, the minutiae data is released from the electronic device 32 and sent to the authentication device 31 for authentication. However, it should be noted that in other embodiments the minutiae data may be pushed to the electronic device 32 for local verification. Thus, a local ridge-flow validation may be used to enable both local and remote standards compliant minutiae comparisons, as will be appreciated by those skilled in the art.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

That which is claimed is:

1. An electronic system comprising:
an authentication device capable of performing authentication based upon a first type of finger biometric template; and
an electronic device comprising
a finger biometric sensor, and
a processor cooperating with the finger biometric sensor and capable of performing authentication based upon a second type of finger biometric template different from the first type of finger biometric template, and generating finger biometric data according to the first type of finger biometric template,
the processor also being capable of cooperating with the authentication device to authenticate the finger biometric data according to the first type of finger biometric template.

2. The electronic system of claim 1 wherein the electronic device further comprises a wireless transceiver; and wherein the processor is capable of sending finger biometric data according to the first type of template to the authentication device via the wireless transceiver based upon an authentication of corresponding finger biometric data of the second type of finger biometric template.

3. The electronic system of claim 1 wherein the first type of biometric template comprises a fingerprint minutiae template.

4. The electronic system of claim 1 wherein the second type of biometric template comprises a fingerprint ridge flow template.

5. The electronic system of claim 1 wherein the processor is capable of encrypting the finger biometric data according to the first type of finger biometric template.

6. The electronic system of claim 1 wherein the processor is configured to cooperate with the finger biometric sensor to simultaneously collect biometric data for both the first type of finger biometric template and the second type of finger biometric template.

7. The electronic system of claim 1 wherein the processor is configured to cooperate with the finger biometric sensor to collect finger biometric data for the second type of finger biometric template and extract therefrom biometric data for the first type of finger biometric template.

8. The electronic system of claim 1 wherein the processor is further capable of cooperating with the authentication device to perform a transaction.

9. The electronic system of claim 8 wherein the transaction comprises at least one of a financial transaction and a physical access transaction.

10. An electronic device to cooperate with an authentication device to perform authentication based upon a first type of finger biometric template, the electronic device comprising:
a finger biometric sensor; and
a processor cooperating with the finger biometric sensor and capable of performing authentication based upon a second type of finger biometric template different from the first type of finger biometric template, and generating finger biometric data according to the first type of finger biometric template;
the processor also capable of cooperating with the authentication device to authenticate the finger biometric data according to the first type of finger biometric template.

11. The electronic device of claim 10 further comprising a wireless transceiver; and wherein the processor is capable of sending finger biometric data according to the first type of template to the authentication device via the wireless transceiver based upon an authentication of corresponding finger biometric data of the second type of finger biometric template.

12. The electronic device of claim 10 wherein the first type of biometric template comprises a fingerprint minutiae template; and the second type of biometric template comprises a fingerprint ridge flow template.

13. The electronic device of claim 10 wherein the processor is capable of encrypting the finger biometric data according to the first type of finger biometric template.

14. The electronic device of claim 10 wherein the processor is configured to cooperate with the finger biometric sensor to simultaneously collect biometric data for both the first type of finger biometric template and second type of finger biometric template.

15. The electronic device of claim 10 wherein the processor is configured to cooperate with the finger biometric sensor to collect finger biometric data for the second type of finger biometric template and extract therefrom biometric data for the first type of finger biometric template.

16. The electronic device of claim 10 wherein the processor is further capable of cooperating with the authentication device to perform a transaction.

17. An authentication method for use with an authentication device to perform authentication based upon a first type of finger biometric template, the method comprising:
operating a processor to
cooperate with a finger biometric sensor to perform authentication based upon a second type of finger biometric template different from the first type of finger biometric template, and generate finger biometric data according to the first type of finger biometric template, and
cooperate with the authentication device to authenticate the finger biometric data according to the first type of finger biometric template.

18. The method of claim 17 wherein operating the processor comprises operating the processor to send finger biometric data according to the first type of template to the authentication device via a wireless transceiver based upon an authentication of corresponding finger biometric data of the second type of finger biometric template.

19. The method of claim 17 wherein the first type of biometric template comprises a fingerprint minutiae template;
and the second type of biometric template comprises a fingerprint ridge flow template.

20. The method of claim 17 wherein operating the processor comprises operating the processor to cooperate with the finger biometric sensor to simultaneously collect biometric data for both the first type of finger biometric template and second type of finger biometric template.

21. The method of claim 17 wherein operating the processor comprises operating the processor to cooperate with the finger biometric sensor to collect finger biometric data for the second type of finger biometric template and extract therefrom biometric data for the first type of finger biometric template.

22. A non-transitory computer-readable medium for an electronic device to cooperate with an authentication device to perform authentication based upon a first type of finger biometric template, the electronic device comprising a finger biometric sensor, the computer-readable medium having computer executable instructions for causing the electronic device to:
perform authentication based upon a second type of finger biometric template different from the first type of finger biometric template based upon the finger biometric sensor;
generate finger biometric data according to the first type of finger biometric template; and
cooperate with the authentication device to authenticate the finger biometric data according to the first type of finger biometric template.

23. The non-transitory computer-readable medium of claim 22 further having computer executable instructions for causing the electronic device to send finger biometric data according to the first type of template to the authentication device via a wireless transceiver based upon an authentication of corresponding finger biometric data of the second type of finger biometric template.

24. The non-transitory computer-readable medium of claim 22 wherein the first type of biometric template comprises a fingerprint minutiae template; and the second type of biometric template comprises a fingerprint ridge flow template.

25. The non-transitory computer-readable medium of claim 22 further having computer-executable instructions for causing the electronic device to cooperate with the finger biometric sensor to simultaneously collect biometric data for both the first type of finger biometric template and second type of finger biometric template.
